(19) United States
(12) Patent Application Publication
(10) Pub. No.: US 2005/0067390 A1
(43) Pub. Date: Mar. 31, 2005

(54) Method of laser etching and product

(76) Inventor: William Gary Cromer, Westminster, SC (US)

Correspondence Address: Ralph Bailey;RALPH BAILEY, P.A., 125 Broadus Avenue, Greenville, SC, 29601, US

(21) Appl. No.: 10/675,902

(22) Filed: Sep. 30, 2003

(51) Int. Cl. B23K 26/36

(52) U.S. Cl. 219/121.69

(57) ABSTRACT

Background areas (A) are etched in opaque substrates (B) having smooth surfaces forming products carrying characters (C) of enhanced visibility by directing a laser beam (D) against opaque substrates while maintaining smooth surface areas free of the effects of the laser beam.

This invention relates to laser etching for forming characters of enhanced visibility in a smooth surface of a product.

### BACKGROUND OF THE INVENTION

The drawings illustrate the Prior Art exemplified by U.S. Pat. No. 4,947,022 wherein a workpiece having a curved surface is laser engraved by being manipulated in a single plane while maintaining the focal point of the laser beam at a plane corresponding to the average working distance between the surface being engraved and the laser's focusing lens, and U.S. Pat. No. 5,880,430 disclosing a method for computer laser etching a design into a workpiece with the aid of a computer and computer peripherals, a laser etching device, and a control program which controls the laser beam. The method is illustrated as being performed by the following steps: the design is input into the computer memory by use of a scanner or other input device; the design may then be scaled to a desired size; the intensity of the laser beam is selected so that only a single layer of material is removed; and the control program directs the laser beam to etch away appropriate material, thus exposing the underlying surface and forming the desired design. The disclosures of these patents are incorporated herein by and made a part hereof by reference.

U.S. Pat. No. 6,559,410 is illustrative of the prior art.

### SUMMARY OF THE INVENTION

Accordingly it is an important object to increase the visibility of characters such as indicia, symbols, pictures, or other characters upon opaque substrates.

Another important object of the invention is to provide background areas carrying smooth raised characters of enhanced visibility.

Still another important object of the invention is achieved by manipulating a laser beam defining smooth surface areas of enhanced visibility defining the characters applied to the substrates forming products therefrom.

While the invention has been described generally in relation to socket tools and tool boxes therefor the invention has application to many other tools and accessories, as well as additional applications in areas other than and in addition to tools and accessories.

### BRIEF DESCRIPTION OF THE DRAWINGS

The construction designed to carry out the invention will be hereinafter described, together with the other features thereof.

The invention will be more readily understood from a reading of the following specification and by reference to the accompanying drawings forming a part thereof, wherein an example of the invention is shown wherein:

FIG. 1 is a schematic illustration of a workpiece being etched by a laser beam wherein characters are formed therein by manipulating the laser and the workpiece to etch the characters leaving the surface of the workpiece otherwise undisturbed;

FIG. 2 is a perspective view of a workpiece similar to that of FIG. 1;

FIG. 3 is a perspective view illustrating a socket tool having a smooth arcuate outer surface carrying indicia indicating size etched therein in accordance with the invention;

FIG. 4 is a plan view illustrating an open compartment in the lower tray of a tool box marked with indicia in accordance with the invention;

FIG. 5 is a perspective view illustrating a tool box having a hinged lid for containing compartments such as illustrated in FIG. 4 providing indicia produced by the method of the invention indicating appropriate compartments for housing sockets constructed in accordance with the invention; and

FIG. 6 is a perspective view illustrating a planar sheet of stainless steel being etched in accordance with the invention.

### DESCRIPTION OF A PREFERRED EMBODIMENT

A method of etching background areas A forming products bearing characters C on opaque substrates B having smooth surfaces of enhanced visibility including, directing a laser beam D of sufficient intensity and duration against opaque substrates. Maintaining smooth surface areas at least partially within background areas defining characters on the substrates substantially free of the laser beam. Thus, smooth surface areas of enhanced visibility defining the characters are applied to the substrates forming the products.

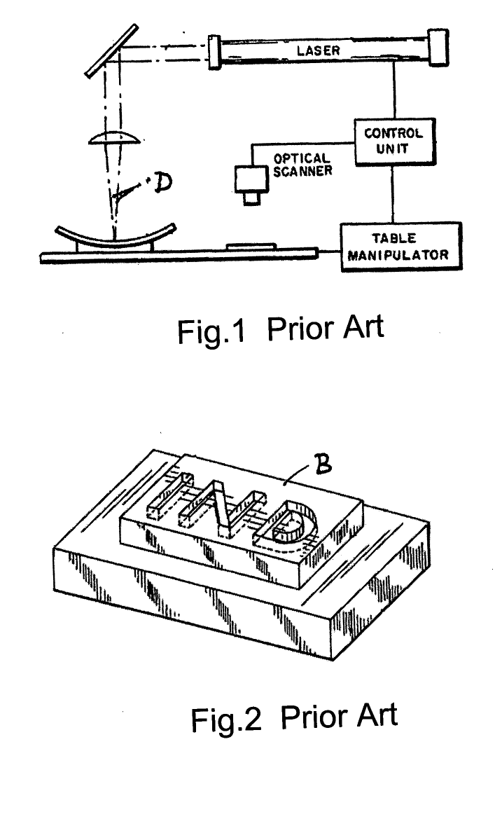

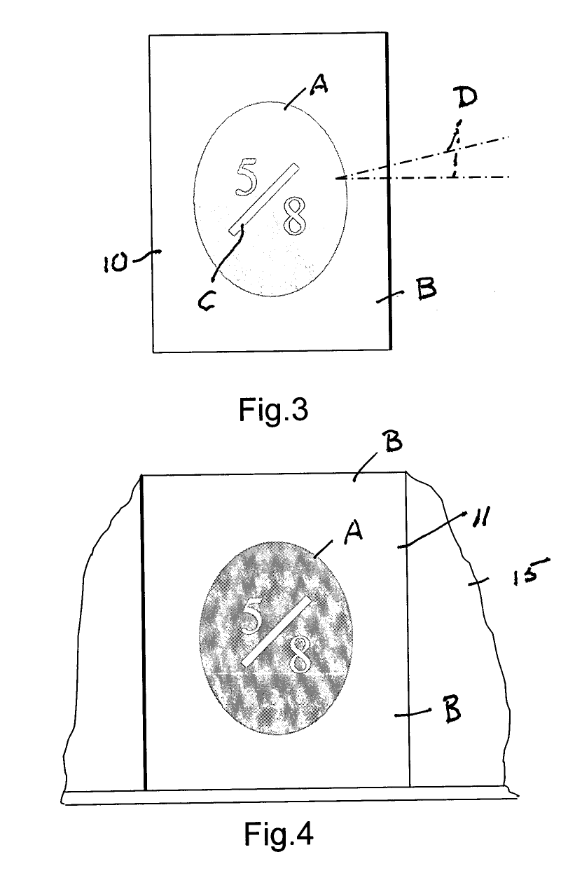

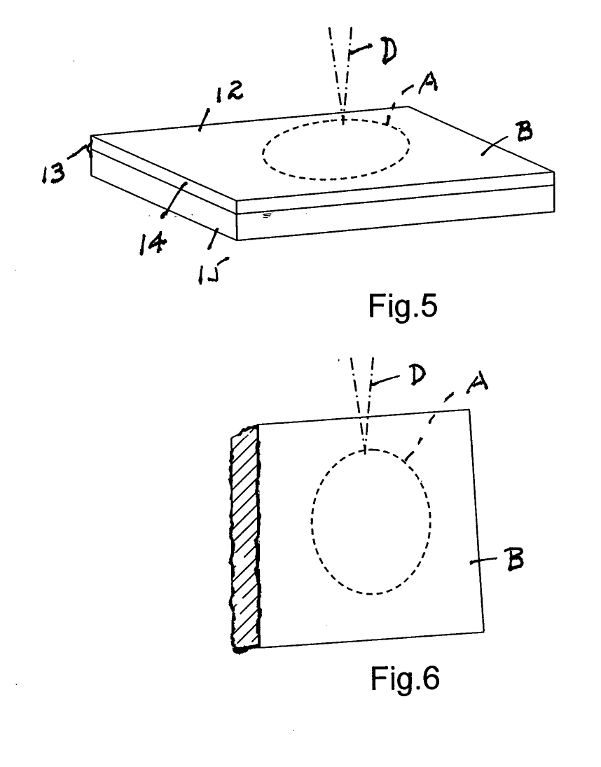

FIG. 1 illustrates the Prior Art in accordance with U.S. Pat. No. 4,947,022 and FIG. 2 illustrates Prior Art the disclosure of U.S. Pat. No. 5,880,430. FIG. 3 illustrates a laser D formed by pulses of the type illustrated at D in FIG. 1 being manipulated to form a background area A in the opaque substrate B. Characters having smooth surface areas C are thereby formed in a socket as illustrated in FIG. 3. The substrate B of such sockets generally includes a chrome outer layer 10 having a protective layer therebeneath, not shown, carried by the body of the socket. The indicia illustrated in the drawings represent the size of the socket to be carried within a convex compartment 11 within the tool box 12. The tool box has a hinge 13 fastening a cover 14 to a lower tray 15 that is carries the compartment 11. A background area A is defined by the broken lines in FIG. 5.

FIG. 6 illustrates a laser D being employed to etch a background area A illustrated in broken lines in a sheet of stainless steel.

While the preferred embodiment of the invention is for illustrative purposes only, it is to be understood that changes and variations may be made in the various substrates and products, and in their manipulation and arrangement without departing from the spirit or scope of the following claims.

1. A method of etching background areas defining characters on opaque substrates having smooth surfaces comprising the steps of:
directing a laser beam of sufficient intensity and duration against opaque substrates ablating background areas of the substrates; and
maintaining smooth surface areas at least partially within said background areas defining characters on the substrates substantially free of the laser beam;
whereby smooth surface areas of enhanced visibility defining said characters are applied to the substrates.

2. A method of etching set forth in claim 1 wherein said substrates are metallic having smooth chrome surfaces and protective material therebeneath.

3. A method of etching set forth in claim 2 wherein said substrates include convex arcuate surfaces defining socket tools.

4. A method set forth in claim 1 wherein said substrates have a smooth arcuate concave surfaces.

5. A method set forth in claim 1 wherein said substrates have a smooth arcuate convex surfaces.

6. A method set forth in claim 1 wherein said substrates have a smooth planar surfaces.

7. A method set forth in claim 1 wherein said substrates are constructed of stainless steel.

8. Products of a method according to claim 1.

9. Products of a method according to claim 2.

10. Products of a method according to claim 3.

11. Products of a method according to claim 4.

12. Products of a method according to claim 5.

13. Products of a method according to claim 6.

14. Products of a method according to claim 7.

15. A method of etching background areas defining characters on opaque substrates having smooth surfaces comprising the steps of:
manipulating a relative direction of a laser beam of sufficient intensity and duration in relation to opaque substrates ablating background areas of the substrates; and
maintaining smooth surface areas at least partially within said background areas defining characters on the substrates substantially free of the laser beam by providing periods of at least reduced laser beam ablation;
whereby smooth surface areas of enhanced visibility defining said characters are applied to the substrates.

16. A method of etching set forth in claim 15 wherein said substrates are metallic having smooth chrome surfaces and protective subsurfaces therebeneath.

17. A method of etching set forth in claim 16 wherein said substrates define socket tools.
